(19) United States
(12) Patent Application Publication
(10) Pub. No.: US 2024/0360364 A1
(43) Pub. Date: Oct. 31, 2024

(54) METHOD FOR MANUFACTURING AN AQUEOUS FIRE RETARDANT COMPOSITION, AN AQUEOUS FIRE RETARDANT COMPOSITION, A METHOD FOR TREATING A WOOD SUBSTRATE THEREWITH, AND A WOOD PRODUCT PRODUCED THEREFROM

(71) Applicant: Koppers Performance Chemicals, Inc., Pittsburgh, PA (US)

(72) Inventors: Bin Li, Senoia, GA (US); Jun Zhang, Peachtree City, GA (US); Douglas Herdman, Peachtree City, GA (US)

(21) Appl. No.: 18/645,809

(22) Filed: Apr. 25, 2024

Related U.S. Application Data
(60) Provisional application No. 63/462,575, filed on Apr. 28, 2023.

(51) Int. Cl. C09K 21/04; C09K 21/02

(52) U.S. Cl. CPC C09K 21/04; C09K 21/02

(57) ABSTRACT

A method for manufacturing an aqueous fire retardant composition, an aqueous fire retardant composition, a method of treating a wood substrate therewith, and a wood product produced therefrom are provided. The method for manufacturing the aqueous fire retardant composition comprises combining a phosphoric acid, an ammonia compound, and a boric acid and contacting the phosphoric acid with the ammonia compound in an aqueous medium to form a reaction product comprising a phosphate salt. The fire retardant composition comprises the reaction product and the aqueous medium.

### CROSS-REFERENCE

The present application claims priority to U.S. Provisional Application No. 63/462,575, filed Apr. 28, 2023, the entire contents of which is hereby incorporated by reference in its entirety.

### FIELD

The present disclosure relates to a method for manufacturing an aqueous fire retardant composition, an aqueous fire retardant composition, a method of treating a wood substrate therewith, and a wood product produced therefrom.

### BACKGROUND

Conventional manufacturing methods for aqueous fire retardant compositions include the dissolution of powders of monoammonium phosphate (MAP), diammonium phosphate (DAP) and boric acid in water. For example, U.S. Pat. No. 4,725,382 discloses a fire retardant composition prepared from a dry mix of MAP, DAP, and boric acid. There are challenges with formulating a fire retardant composition from MAP, DAP, and boric acid.

### SUMMARY

The present disclosure provides a method for manufacturing an aqueous fire retardant composition. The method comprises combining a phosphoric acid, an ammonia compound, and a boric acid and contacting the phosphoric acid with the ammonia compound in an aqueous medium to form a reaction product comprising a phosphate salt. The fire retardant composition comprises the reaction product and the aqueous medium.

The present disclosure also provides a fire retardant composition formed by a method for manufacturing an aqueous fire retardant composition. The method comprises combining a phosphoric acid, an ammonia compound, and a boric acid and contacting the phosphoric acid with the ammonia compound in an aqueous medium to form a reaction product comprising a phosphate salt. The fire retardant composition comprises the reaction product and the aqueous medium.

The present disclosure also provides a method for treating a wood product. The method comprising contacting the wood product with a fire retardant composition formed by a method for manufacturing an aqueous fire retardant composition. The method for manufacturing the aqueous fire retardant composition comprises combining a phosphoric acid, an ammonia compound, and a boric acid and contacting the phosphoric acid with the ammonia compound in an aqueous medium to form a reaction product comprising a phosphate salt. The fire retardant composition comprises the reaction product and the aqueous medium.

The present disclosure also provides a fire retardant wood product formed by contacting a wood product with the fire retardant composition formed by a method for manufacturing an aqueous fire retardant composition. The method for manufacturing the first retardant composition comprises combining a phosphoric acid, an ammonia compound, and a boric acid and contacting the phosphoric acid with the ammonia compound in an aqueous medium to form a reaction product comprising a phosphate salt. The fire retardant composition comprises the reaction product and the aqueous medium.

The present disclosure also provides a method for manufacturing a fire retardant composition. The method comprising combining orthophosphoric acid and orthoboric acid to form an intermediate mixture, wherein the intermediate mixture comprises a molar ratio of orthophosphoric acid to orthoboric acid in a range of 2.5 to 3.0. The method comprises combining aqueous ammonia hydroxide with the intermediate mixture to achieve a molar ratio of orthophosphoric acid to aqueous ammonia hydroxide in a range of 0.40 to 0.8. The aqueous ammonia hydroxide is added to the intermediate mixture at a rate no greater than 10% of a total volume of the aqueous ammonia hydroxide per minute. The method comprises contacting the orthophosphoric acid with the aqueous ammonia hydroxide to form a reaction product comprising at least one of monoammonium phosphate and diammonium phosphate. The fire retardant composition comprises the reaction product and the orthoboric acid.

It is understood that the inventions described in this specification are not limited to the examples summarized in this Summary. Various other aspects are described and exemplified herein.

### DETAILED DESCRIPTION

Certain exemplary aspects of the present disclosure will now be described to provide an overall understanding of the principles of the structure, function, manufacture, and use of the compositions, methods, and products disclosed herein. One or more examples of these aspects are illustrated in the accompanying drawings. Those of ordinary skill in the art will understand that the devices and methods specifically described herein and illustrated in the accompanying drawings are non-limiting exemplary aspects and that the scope of the various examples of the present disclosure is defined solely by the claims. The features illustrated or described in connection with one exemplary aspect may be combined with the features of other aspects. Such modifications and variations are intended to be included within the scope of the present disclosure.

Any reference herein to “various examples,” “some examples,” “one example,” “an example,” similar references to “aspects,” or the like, means that a particular feature, structure, or characteristic described in connection with the example is included in at least one example. Thus, appearances of the phrases “in various examples,” “in some examples,” “in one example,” “in an example,” similar references to “aspects,” or the like, in places throughout the specification are not necessarily all referring to the same example. Furthermore, the particular features, structures, or characteristics may be combined in any suitable manner in one or more examples. Thus, the particular features, structures, or characteristics illustrated or described in connection with one example may be combined, in whole or in part, with the features, structures, or characteristics of one or more other examples without limitation. Such modifications and variations are intended to be included within the scope of the present examples.

Conventional manufacturing methods for aqueous fire retardant compositions include the dissolution of powders for monoammonium phosphate (MAP), diammonium phosphate (DAP), and boric acid in water. However, utilizing powders may be inefficient, undesirable, and require additional handling considerations. In addition, MAP and DAP may form cakes during storage and/or shipping that are undesirable and can be difficult to process. The present inventors have identified certain desirable aspects of an aqueous fire retardant composition that comprises phosphates and boron compounds.

The present disclosure provides a method for manufacturing an aqueous fire retardant composition that comprises a phosphate salt and boric acid. The phosphate salt can comprise ammonium phosphate, such as, for example, at least one of monoammonium phosphate and diammonium phosphate. The method according to the present disclosure can increase the efficiency of manufacturing and require less handling considerations.

An example of a method for manufacturing an aqueous fire retardant composition according to the present disclosure comprises a combining step wherein a phosphoric acid, an ammonia compound, and a boric acid may be combined in various forms and arrangements to form the aqueous fire retardant composition as known to those of ordinary skill in the art. For example, all or part of one or more of the phosphoric acid, the ammonia compound, and the boric acid can be combined in series or in various combinations in either batch or continuous operations.

For example, the boric acid and the phosphoric acid can be combined to form an intermediate mixture and thereafter, the intermediate mixture can be combined with the ammonia compound. In various examples, the ammonia compound can be added to the intermediate mixture at a rate no greater than 10% of a total volume of the ammonia compound per minute, such as, for example, no greater than 5% of a total volume of the ammonia compound per minute.

In certain examples, the ammonia compound and the aqueous medium can be combined to form an intermediate mixture and thereafter, the intermediate mixture can be combined with the phosphoric acid and the boric acid.

In certain other examples, the ammonia compound and the boric acid can be combined to form an intermediate mixture and thereafter, the intermediate mixture can be combined with the phosphoric acid.

In certain other examples, the phosphoric acid and the ammonia compound can be combined to form an intermediate mixture and thereafter, the intermediate mixture can be combined with the boric acid.

The phosphoric acid can comprise at least one of orthophosphoric acid, pyrophosphoric acid, triphosphoric acid, and tetraphosphoric acid. In various examples, the phosphoric acid comprises 10% by weight to 100% by weight active content based on a total weight of the phosphoric acid, such as, for example, 75% by weight to 85% by weight active content based on a total weight of the phosphoric acid. The phosphoric acid can be in a liquid state at 20 degrees Celsius and 1 atmosphere absolute.

The ammonia compound can comprise aqueous ammonia (e.g., aqueous ammonium hydroxide, aqua ammonia, liquid ammonia). In various examples where the ammonia compound is the aqueous ammonia, the aqueous ammonia can comprise 10% by weight to 30% by weight active content of ammonia based on a total weight of the aqueous ammonia, such as, for example, 19% by weight to 21% by weight active content of ammonia based on a total weight of the aqueous ammonia. The ammonia compound can be in a liquid state at 20 degrees Celsius and 1 atmosphere absolute. The use of liquid ammonia compound and liquid phosphoric acid can enable a more efficient reaction and facilitate handling of the components.

The boric acid can comprise at least one of orthoboric acid, metaboric acid, and tetraboric acid. In various examples, the boric acid comprises a purity of at least 95% by weight, such as, for example, a purity of at least 98% by weight. The boric acid can be in a solid state at 20 degrees Celsius and 1 atmosphere absolute. The use of solid boric acid can enable an endothermic dissolution process of the solid boric acid into the aqueous medium.

The aqueous medium can be water. The aqueous medium can be added separately and/or the aqueous medium can be included with at least one of the phosphoric acid and the ammonia compound.

The method further comprises a contacting step, wherein the phosphoric acid is contacted with the ammonia compound in an aqueous medium to form a reaction product comprising a phosphate salt. Contacting can comprise one or more forms of agitating, such as, for example, mixing with a paddle, centrifugal mixing, utilizing a mixing nozzle, utilizing a mixing bed, or other suitable agitation techniques. In certain examples, the combining step and the contacting step are performed simultaneously.

In various examples, the combining step and contacting step are performed in a mixing system including an agitated vessel with a cooling jacket, a condenser attached to the vessel, a thermal couple to measure the reaction temperature, raw material metering systems (e.g., for the aqueous medium, phosphoric acid, and ammonia compound), and a powder feeding system (e.g., for the boric acid). The vessel can be equipped with load cells to verify the amounts of raw materials charged into the tank.

In various examples, the general mechanism whereby orthophosphoric acid can react with ammonium hydroxide in the contacting step is illustrated according to Scheme 1 below.

Scheme 1

H₃PO₄+NH₄OH⇄(NH₄)₃PO₄+H₂O

The chemical reaction of the ammonia compound and the phosphoric acid can be exothermic and the dissolution of the boric acid into the aqueous medium can be endothermic. Therefore, the dissolution of the boric acid into the aqueous medium can be enhanced by the heat produced from the exothermic reaction. The endothermic reaction can absorb excess heat from the exothermic reaction, which may reduce the amount of cooling required for the reaction. The synergistic effect of both an exothermic reaction and an endothermic reaction occurring during the formation of the fire retardant composition can enable a more efficient production process.

The phosphoric acid and ammonia compound can be combined in suitable amounts to form the phosphate salt. For example, the phosphoric acid and the ammonia compound can be combined in amounts to achieve a molar ratio of phosphoric acid to ammonia in a range of 0.40 to 0.80. In various examples, the phosphoric acid and the boric acid can be combined in amounts to achieve a molar ratio of phosphoric acid to boric acid in a range of 2.0 to 4.0.

Combining the phosphoric acid, the ammonia compound, and the boric acid can be performed at a suitable temperature and a suitable pressure to facilitate formation of the reaction product and maintain efficient conditions in a vessel used to for the combination. For example, a temperature (e.g., reaction temperature) during the combining can be in a range of 5 degrees Celsius to 85 degrees Celsius, such as, for example, 20 degrees Celsius to 80 degrees Celsius. A pressure during the combination may be in a range of 10 PSIA to 25 PSIA. In various examples, external cooling may be performed. For example, the vessel used for the combination can be water jacketed.

In various examples, the combining can be performed with condensation. For example, a condenser may be attached to the vessel used for the combination and reflux vapors formed from the combination may be cooled, condensed, and returned into the liquid solution.

The fire retardant composition may comprise the reaction product and the aqueous medium. The fire retardant composition can comprise a phosphate content expressed as P₂O₅ in a range of 15% by weight to 40% by weight based on a total weight of the fire retardant composition, a boric acid content expressed as H₃BO₃ in a range of 5% by weight to 10% by weight based on the total weight of the fire retardant composition, and an ammonium content expressed as NH₃ in a range of 5% by weight to 15% by weight based on the total weight of the fire retardant composition. In various examples, the fire retardant composition can comprise a phosphate content expressed as P₂O₅ in a range of 15% by weight to 30% by weight based on a total weight of the fire retardant composition, a boric acid content expressed as H₃BO₃ in a range of 6% by weight to 9% by weight based on the total weight of the fire retardant composition, and an ammonium content expressed as NH₃ in a range of 7% by weight to 12% by weight based on the total weight of the fire retardant composition. The determination of P₂O₅, H₃BO₃, and NH₃ can be according to AWPA P50-21 (2022).

In various examples, the pH of the fire retardant composition is in a range of 5.0 to 8.0, such as, for example, 5.5 to 7.5.

The fire retardant composition according to the present disclosure can be a concentrated composition or a diluted composition. For example, the fire retardant composition can be diluted with another aqueous solvent, which may be the same or different than the aqueous medium used to formulate the first retardant composition. In various examples, the diluted fire retardant composition may be directly formed without first forming the concentrated composition.

The fire retardant composition according to the present disclosure can be formulated with a de-emulsifier that can inhibit emulsion formation and facilitate water separation from any organic solvent phase. In various examples, the de-emulsifier can comprise a surfactant, a defoamer, an anti-foaming agent, other type of surface modifying agent, or a combination thereof. The de-emulsifier can comprise a siloxane (e.g., a polysiloxane, a 3-dimensional siloxane), a polysilane, an alkylphenol formaldehyde resin alkoxylate, a polyalkylene glycol, a sulfonate (e.g., an organic sulfonate), a polyglycol ether, a phenol oxylate, a naltyl phenol acetoxide derivative, or a combination thereof. For example, the de-emulsifier can comprise a Stepan series de-emulsifiers (e.g., Agent NE-3A, NE-3B, Toximul 8244); Dow Chemicals DM series de-emulsifiers (e.g., DM3, DM5, DM6); Evonik Tego Foamex series de-emulsifiers (e.g., 843, 844, 883, Surfynol 420); Demtrol series de-emulsifiers (e.g., 1030, 1040, 1130, 1135E, 2030,2045, 4026, 6055, 6237); Reziflow series de-emulsifiers (e.g., 2110, 2215, 2130, 2140, 2205, 2210, 2300, 2305, 2600, 2605, 2720, 2740); a Munzing series of FOAM BAN products (FOAM BAN® 130B, 149, 152, 1536, 154, 155, 1550, 159, 169, 1820, 1839, 1840, 1849, 1860, 1875, 1880, 1890, 204, 225D, 257, 2642, 267D, 2699, 3057, 3555, 3633E, 4901, 4940, 4950, 4960, 4990, EC200, EC210, HP750, HP753N, HP758, HP920, HP930, HP939, HP940, HP949, HP970, HP979, HP980, HP990, MS-525, MS-550, MS-575, MS-5A, SB-73, TK-150, TK-320, Tk-340, Tk-360, TK-75 and TS-2000) or a combination thereof.

The fire retardant composition according to the present disclosure can also optionally comprise a colorant, an ultraviolet (UV) stabilizer, a UV absorber, a de-foamer, a water repellent, an additional fire retardant, a biocide, a fungicide, a termiticide, or a combination thereof.

The UV stabilizer can comprise copper oxide, a copper salt, iron oxide, iron complexes, transparent iron oxide, iron salts, nanoparticle iron oxide, titanium dioxide, benzophenone, substituted benzophenones, cinnamic acid, esters of cinnamic acid, amides of cinnamic acid, substituted triazines (e.g., triphenyl triazaine, substituted phenyl triazine), or combinations thereof.

The UV absorber can comprise benzotriazole, substituted benzotriazole, hindered amine light stabilizers, or combinations thereof.

The water repellent can comprise a wax water repellent (e.g., paraffin wax, polyethylene wax, carnauba wax, slack wax), a silicone, or a combination thereof.

The additional fire retardant can be one or more compounds selected from the group consisting of inorganic metal oxides, hydroxides, salts and expandable graphite phosphate compounds, nitrogen-containing compounds, dipentaerythritol, pentaerythritol, dextrin, and boron-containing compounds.

The biocide can comprise a creosote, a triazole, an imidazole, a pyrazole, a boron compound, a quaternary ammonium, an isothiazolone, a pyrethroid, copper metal, a copper compound, pentachlorophenol, bethoxazin, or a combination thereof.

Triazole and imidazole can comprise: 1-[[2-(2,4-dichlorophenyl)-1,3-dioxolan-2-yl]methyl]-1H-1,2,4-triazole(azaconazole), 1-[(2RS,4RS:2RS,4SR)-4-bromo-2-(2,4-dichlorophenyl)tetrahydrofurfuryl]-1H-1,2,4-triazole(bromuconazole), (2RS,3RS;2RS,3SR)-2-(4-chlorophenyl)-3-cyclopropyl-1-(1H-1,2,4-triazol-1-yl) butan-2-ol (Cyproconazole), (2RS,3RS)-1-(2,4-dichlorophenyl)-4,4-dimethyl-2-(1H-1,2,4-triazol-1-yl)pentan-3-ol (diclobutrazol), cis-trans-3-chloro-4-[4-methyl-2-(1H-1,2,4-triazol-1-ylmethyl)-1,3-dioxolan-2-yl]phenyl 4-chlorophenyl ether (difenoconazole), (E)-(RS)-1-(2,4-dichlorophenyl)-4,4-dimethyl-2-(1H-1,2,4-triazol-1-yl) pent-1-en-3-ol (diniconazole), (E)-(R)-1-(2,4-dichlorophenyl)-4,4-dimethyl-2-(1H-1,2,4-triazol-1-yl) pent-1-cn-3-ol (diniconazole-M), (2RS,3SR)-1-[3-(2-chlorophenyl)-2,3-epoxy-2-(4-fluorophenyl) propyl]-1H-1,2,4-triazole (epoxiconazole), (RS)-1-[2-(2,4-dichlorophenyl)-4-ethyl-1,3-dioxolan-2-ylmethyl]-1H-1,2,4-triazole (etaconazole), (RS)-4-(4-chlorophenyl)-2-phenyl-2-(1H-1,2,4-triazol-1-ylmethyl) butyronitrile (fenbuconazole), 3-(2,4-dichlorophenyl)-6-fluoro-2-(1H-1,2,4-triazol-1-yl) quinazolin-4 (3H)-one (fluquinconazole), bis (4-fluorophenyl)(methyl)(1H-1,2,4-triazol-1-ylmethyl)silane (flusilazole), (RS)-2,4′-difluoro-α-(1H-1,2,4-triazol-1-ylmethyl)benzhydryl alcohol (flutriafol), (2RS,5RS;2RS,5SR)-5-(2,4-dichlorophenyl)tetrahydro-5-(1H-1,2,4-triazol-1-ylmethyl)-2-furyl 2,2,2-trifluoroethyl ether (furconazole), (2RS,5RS)-5-(2,4-dichlorophenyl)tetrahydro-5-(1H-1,2,4-triazol-1-ylmethyl)-2-furyl 2,2,2-trifluoroethyl ether (furconazole-cis), (RS)-2-(2,4-dichlorophenyl)-1-(1H-1,2,4-triazol-1-yl) hexan-2-ol (hexaconazole), 4-chlorobenzyl (EZ)-N-(2,4-dichlorophenyl)-2-(1H-1,2,4-triazol-1-yl) thioacetamidate (imibenconazole), (IRS,2SR,5RS;1RS,2SR,5SR)-2-(4-chlorobenzyl)-5-isopropyl-1-(1H-1,2,4-triazol-1-ylmethyl)cyclopentanol (ipconazole), (1RS,5RS;1RS,5SR)-5-(4-chlorobenzyl)-2,2-dimethyl-1-(1H-1,2,4-triazol-1-ylmethyl)cyclopentanol (metconazole), (RS)-2-(4-chlorophenyl)-2-(1H-1,2,4-triazol-1-ylmethyl)hexanenitrile (myclobutanil), (RS)-1-(2,4-dichloro-β-propylphenethyl)-1H-1,2,4-triazole(penconazole), cis-trans-1-[2-(2,4-dichlorophenyl)-4-propyl-1,3-dioxolan-2-ylmethyl]-1H-1,2,4-triazole (propiconazole), (RS)-2-[2-(1-chlorocyclopropyl)-3-(2-chlorophenyl)-2-hydroxypropyl]-2,4-dihydro-1,2,4-triazole-3-thione (prothioconazole), 3-(2,4-dichlorophenyl)-2-(1H-1,2,4-triazol-1-yl)-quinazolin-4 (3H)-one (quinconazole), (RS)-2-(4-fluorophenyl)-1-(1H-1,2,4-triazol-1-yl)-3-(trimethylsilyl)propan-2-ol (simeconazole), (RS)-1-p-chlorophenyl-4,4-dimethyl-3-(1H-1,2,4-triazol-1-ylmethyl) pentan-3-ol (tebuconazole), propiconazole, (RS)-2-(2,4-dichlorophenyl)-3-(1H-1,2,4-triazol-1-yl)propyl 1,1,2,2-tetrafluoroethyl ether (tetraconazole), (RS)-1-(4-chlorophenoxy)-3,3-dimethyl-1-(1H-1,2,4-triazol-1-yl) butan-2-one (triadimefon), (1RS,2RS;1RS,2SR)-1-(4-chlorophenoxy)-3,3-dimethyl-1-(1H-1,2,4-triazol-1-yl)butan-2-ol (triadimenol), (RS)-(E)-5-(4-chlorobenzylidene)-2,2-dimethyl-1-(1H-1,2,4-triazol-1-ylmethyl)cyclopentanol (triticonazole), (E)-(RS)-1-(4-chlorophenyl)-4,4-dimethyl-2-(1H-1,2,4-triazol-1-yl) pent-1-en-3-ol (uniconazole), (E)-(S)-1-(4-chlorophenyl)-4,4-dimethyl-2-(1H-1,2,4-triazol-1-yl) pent-1-en-3-ol (uniconazole-P), 2-(2,4-difluorophenyl)-1-(1H-1,2,4-triazole-1-yl)-3-trimethylsilyl-2-propanol, or a combination thereof. Other azole compounds suitable as an additional biocide can comprise amisulbrom, bitertanol, fluotrimazole, triazbutil, climbazole, clotrimazole, imazalil, oxpoconazole, prochloraz, triflumizole, azaconazole, simeconazole, hexaconazole, or a combination thereof.

The pyrazole can comprise: benzovindiflupyr, bixafen, fenpyrazamine, fluxapyroxad, furametpyr, isopyrazam, oxathiapiprolin, penflufen, penthiopyrad, pydiflumetofen, pyraclostrobin, pyrametostrobin, pyraoxystrobin, rabenzazole, sedaxane, or a combination thereof.

The boron compound can comprise water-insoluble boron compounds, such as, for example, metal borate compounds (e.g., calcium borate, borate silicate, aluminum silicate borate hydroxide, silicate borate hydroxide fluoride, hydroxide silicate borate, sodium silicate borate, calcium silicate borate, aluminum borate, boron oxide, magnesium borate, iron borate, copper borate, zinc borate (borax)), or combinations thereof.

The quaternary ammonium can comprise didecyldimethylammonium chloride; didecyldimethylammonium carbonate/bicarbonate; alkyldimethylbenzylammonium chloride; alkyldimethylbenzylammonium carbonate/bicarbonate; didodecyldimethylammonium chloride; didodecyldimethylammonium carbonate/bicarbonate; didodecyldimethylammonium propionate; N,N-didecyl-N-methyl-poly (oxyethyl) ammonium propionate, or a combination thereof.

The isothiazolone can comprise methylisothiazolinone; 5-chloro-2-methyl-4-isothiazoline-3-one, 2-methyl-4-isothiazoline-3-one, 2-n-octyl-4-isothiazoline-3-one, 4,5-dichloro-2-n-octyl-4-isothiazoline-3-one, 2-ethyl-4-isothiazoline-3-one, 4,5-dichloro-2-cyclohexyl-4-isothiazoline-3-one, 5-chloro-2-ethyl-4-isothiazoline-3-one, 2-octyl-3-isothiazolone, 5-chloro-2-t-octyl-4-isothiazoline-3-one, 1,2-benzisothiazoline-3-one, preferably 5-chloro-2-methyl-4-isothiazoline-3-one, 2-methyl-4-isothiazoline-3-one, 2-n-octyl-4-isothiazoline-3-one, 4,5-dichloro-2-n-octyl-4-isothiazoline-3-one, 1,2-benzisothiazoline-3-one, etc., more preferably 5-chloro-2-methyl-4-isothiazoline-3-one, 2-n-octyl-4-isothiazoline-3-one, 4,5-dichloro-2-n-octyl-4-isothiazoline-3-one, 1,2-benzisothiazoline-3-one, chloromethylisothiazolinone, 4,5-Dichloro-2-n-octyl-3 (2H)-isothiazolone, 1,2-benzisothiazolin-3-one, or a combination thereof.

The pyrethroid can comprise: acrinathrin, allethrin, bioallethrin, barthrin, bifenthrin, biocthanomethrin, cyclethrin, cycloprothrin, cyfluthrin, beta-cyfluthrin, cyhalothrin, gamma-cyhalothrin, lambda-cyhalothrin, cypermethrin, alpha-cypermethrin, beta-cypermethrin, theta-cypermethrin, zeta-cypermethrin, cyphenothrin, deltamethrin, dimefluthrin, dimethrin, empenthrin, fenfluthrin, fenpirithrin, fenpropathrin, fenvalerate, esfenvalerate, flucythrinate, fluvalinate, tau-fluvalinate, furethrin, imiprothrin, metofluthrin, permethrin, biopermethrin, transpermethrin, phenothrin, prallethrin, profluthrin, pyresmethrin, resmethrin, bioresmethrin, cismethrin, tefluthrin, terallethrin, tetramethrin, tralomethrin, transfluthrin, etofenprox, flufenprox, halfenprox, protrifenbute, silafluofen, or a combination thereof.

The biocide can comprise imidachloprid, fipronil, cyfluthrin, bifenthrin, permethrin, cypermethrin, chlorpyrifos, iodopropynyl butylcarbamate (IPBC), chlorothalonil, 2-(thiocyanatomethylthio) benzothiazole, alkoxylated diamines, carbendazim, or a combination thereof. The additional biocide can comprise a bactericide, a moldicide, or a combination thereof.

The present disclosure also provides a method of treating a wood substrate, thereby forming a fire retardant wood product. The method comprises contacting a wood substrate with the fire retardant composition according to the present disclosure for a period of time suitable to provide fire retardant properties to the wood substrate. The method of treating the wood substrate can inhibit the start and/growth of fire on the wood substrate. Contacting the wood substrate can comprise dipping, soaking, spraying, brushing, a vacuum process, a pressure process, a microwave process, or a combination thereof.

The present disclosure also provides a wood product produced by treating a wood substrate with the wood preservative composition according to the present disclosure. The wood substrate can comprise timber, plywood, laminated veneer lumber (LVL), cross laminated timber (CTL), parallel strand lumber (PSL), structural glued laminated timber, particle board, dimensional lumber, or a combination thereof. In various examples, the wood substrate comprises a deck, a rail, a fence, a utility pole, a pile, a railway tic, a railroad bridge, cladding, siding, or a combination thereof.

The wood substrate can comprise various species of wood. For example, the wood substrate can comprise southern pine, Douglas fir, Jack pine, red pine, Lodgepole pine, radiata pine, Alaska yellow cedar, Hem-fir, Nordic pine, Scotts pine, white spruce, Spruce-Pine-Fir, redwood, white oak, red oak, maple, black and red gum, Norway spruce, Sitka spruce, western red cedar, western larch, ponderosa pine, or a combination thereof.

### EXAMPLES

The present disclosure will be more fully understood by reference to the following examples that provide illustrative non-limiting aspects of the invention. It is understood that the invention described in this specification is not necessarily limited to the examples described in this section.

Elemental analysis for Boron and Phosphorous were determined by ICP-OES. Element analysis for Nitrogen was determined by the Kjeldahl method.

As used herein, room temperature refers to a temperature of approximately 20 degrees Celsius.

### Example 1: Preparation of a Fire Retardant Composition With Cooling

To a 1 L four neck round bottom flask, 22.41 g of water, 173.30 g of 85% orthophosphoric acid, and 33.75 g of orthoboric acid were added. The flask was placed in a cooling bath filled with 2 kg of water and the solution in the flask was agitated with a magnetic stirrer to form a turbid suspension. 220.55 g of 20% aqua ammonia (e.g., ammonia in water) was added dropwise through a 250 mL graduated addition funnel with a pressure equalizing line at a suitable speed with continuous stirring. The reaction was performed four times with four different speeds for addition of the aqua ammonium. The speeds were 3 mL aqua ammonia per minute, 5.3 mL aqua ammonia per minute, 10.3 mL aqua ammonia per minute, and 19 mL aqua ammonia per minute. The reaction mixture temperature and the bath temperature were monitored with a thermometer. After the addition of aqua ammonia, the reaction mixture was stirred until a clear solution was formed. The clear solution was then cooled down to room temperature. The solution obtained (˜450 g) was characterized by density, pH, viscosity, and elemental analysis. The reaction conditions and the analysis of the solution are shown in Tables 1 and 2 below.

TABLE 1
Reaction conditions for Example 1

| Reac- | Aqua Ammonia | Start Temp | Max Reac- | Max Bath |
|---|---|---|---|---|
| tion | addition speed | of bath and | tion Temp | Temp |
| ID | (mL/min) | reaction (° C.) | (° C.) | (° C.) |
| 1-1 | 3.0 | 20 | 40 | 28 |
| 1-2 | 5.3 | 20 | 44 | 29 |
| 1-3 | 10.3 | 20 | 50 | 29 |
| 1.4 | 19.0 | 20 | 55 | 29 |

TABLE 2
Analysis of Example 1

| | | | Viscosity | | | |
|---|---|---|---|---|---|---|
| Sample | | | (sp61, 12 | Boron | Phosphorous | Nitrogen |
| ID | Density | pH | rpm, cPs) | content | content | content |
| 1-1 | 10.73 | 6.48 | 6.0 | 1.29 | 10.00 | 7.61 |
| 1-2 | 10.73 | 6.45 | 17.0 | 1.30 | 10.01 | 7.79 |
| 1-3 | 10.73 | 6.43 | 22.0 | 1.29 | 9.98 | 8.02 |
| 1-4 | 10.72 | 6.30 | 23.0 | 1.28 | 9.91 | 7.42 |

### Example 2: Preparation of a Fire Retardant Composition Without Cooling

To a 1 L four neck round bottom flask equipped with a condenser, 22.41 g of water, 173.30 g of 85% orthophosphoric acid, and 33.75 g of orthoboric acid were added. The mixture was agitated with a magnetic stirrer to form a turbid suspension. 220.55 g of 20% aqua ammonia was added dropwise through a 250 mL graduated addition funnel with a pressure equalizing line at a speed of 19 mL/min with continuous stirring. The reaction mixture temperature was monitored with a thermometer. After the addition of aqua ammonia, the reaction mixture was stirred until a clear solution was formed. Then, the clear solution was cooled down to room temperature. The solution obtained (450 g) was characterized by density, pH, viscosity, and elemental analysis. The reaction conditions and the analysis of the solution are shown in Tables 3 and 4 below.

TABLE 3
Reaction conditions for Example 2

| Reaction | Aqua Ammonia addition | Start Temp of | Max Reaction |
|---|---|---|---|
| ID | speed (mL/min) | bath (° C.) | Temp (° C.) |
| 2 | 19.0 | 20 | 85 (reflux) |

TABLE 4
Analysis of Example 2

| | | | Viscosity | | | |
|---|---|---|---|---|---|---|
| Sample | | | (sp61, 12 | Boron | Phosphorous | Nitrogen |
| ID | Density | pH | rpm, cPs) | content | content | content |
| 2 | 10.73 | 6.34 | 26.0 | 1.21 | 10.00 | 7.67 |

### Example 3: Preparation of a Fire Retardant Composition With Cooling

To a 1 L four neck round bottom flask, 49.50 g of water, 196.20 g of 75% orthophosphoric acid, and 33.75 g of orthoboric acid were added. The flask was placed in a cooling bath filled with 2 kg of water and then agitated with a magnetic stirrer to form a turbid suspension. 220.55 g of 20% aqua ammonia was added dropwise through a 250 mL graduated addition funnel with a pressure equalizing line at a suitable speed with continuous stirring. The reaction was performed four times with four different speed for addition of the aqua ammonium. The speeds were 2.8 mL aqua ammonia per minute, 5.4 mL aqua ammonia per minute, 10.8 mL aqua ammonia per minute, and 20.7 mL aqua ammonia per minute. The reaction mixture temperature and the bath temperature were monitored with a thermometer. After the addition of aqua ammonia, the reaction mixture was stirred until a clear solution was formed. Then, the clear solution was cooled down to room temperature. The solution obtained (450 g) was characterized by density, pH, viscosity, and elemental analysis. The reaction conditions and the analysis of the solution are shown in Tables 5 and 6.

TABLE 5
Reaction conditions for Example 3

| Reac- | Aqua Ammonia | Start Temp | Max Reac- | Max Bath |
|---|---|---|---|---|
| tion | addition speed | of bath and | tion Temp | Temp |
| ID | (mL/min) | reaction (° C.) | (° C.) | (° C.) |
| 3-1 | 2.8 | 20 | 33 | 28 |
| 3-2 | 5.4 | 20 | 38 | 30 |
| 3-3 | 10.8 | 20 | 47 | 27 |
| 3.4 | 20.7 | 20 | 56 | 25 |

TABLE 6
Analysis of Example 3

| | | | Viscosity | | | |
|---|---|---|---|---|---|---|
| Sample | | | (sp61, 100 | Boron | Phosphorous | Nitrogen |
| ID | Density | pH | rpm, cPs) | content | content | content |
| 3-1 | 10.53 | 6.19 | 1.80 | 1.29 | 10.00 | 7.61 |
| 3-2 | 10.53 | 6.22 | 1.20 | 1.30 | 10.01 | 7.79 |
| 3-3 | 10.51 | 6.17 | 2.52 | 1.29 | 9.98 | 8.02 |
| 3-4 | 10.52 | 6.14 | 2.10 | 1.28 | 9.91 | 7.42 |

### Example 4: Preparation of a Fire Retardant Composition

To a 1 L four neck round bottom flask equipped with a condenser, 22.41 g of water, 220.55 g of 20% aqua ammonia, and 33.75 g of orthoboric acid were added. The flask was placed in a cooling bath filled with 2 kg of water and then agitated with a magnetic stirrer to form a turbid suspension. 173.30 g of 85% orthophosphoric acid was added dropwise through a 250 mL graduated addition funnel with a pressure equalizing line at a suitable speed with continuous stirring. The reaction mixture temperature and the bath temperature were monitored with a thermometer. After the addition of orthophosphoric acid, the reaction mixture was stirred until a clear solution was formed. Then, the clear solution was cooled down to room temperature.

### Example 5: Preparation of a Fire Retardant Composition

To a 1 L four neck round bottom flask equipped with a condenser, 173.30 g of 85% orthophosphoric acid was added. The flask was placed in a cooling bath filled with 2 kg of water and then agitated with a magnetic stirrer. A mixture of 22.41 g of water, 220.55 g of 20% aqua ammonia, and 33.75 g of orthoboric acid was added dropwise through a graduated addition funnel with a pressure equalizing line at a suitable speed with continuous stirring. The reaction mixture temperature and the bath temperature were monitored with a thermometer. After the addition, the reaction mixture was stirred until a clear solution was formed. Then, the clear solution was cooled down to room temperature.

### Example 6: Preparation of a Fire Retardant Composition

To a 1 L four neck round bottom flask equipped with a condenser, 220.55 g of 20% aqua ammonia was added. The flask was placed in a cooling bath filled with 2 kg of water and then agitated with a magnetic stirrer. A mixture of 22.41 g of water, 173.30 g of 85% orthophosphoric acid, and 33.75 g of orthoboric acid was added dropwise through a graduated addition funnel with a pressure equalizing line at a suitable speed with continuous stirring. The reaction mixture temperature and the bath temperature were monitored with a thermometer. After the addition, the reaction mixture was stirred until a clear solution was formed. Then, the clear solution was cooled down to room temperature.

### Example 7: Preparation of a Fire Retardant Composition

To a 1 L four neck round bottom flask equipped with a condenser, 22.41 g of water and 173.30 g of 85% orthophosphoric acid was added. The flask was placed in a cooling bath filled with 2 kg of water and then agitated with a magnetic stirrer. 220.55 g of 20% aqua ammonia was added dropwise through a graduated addition funnel with pressure equalizing line at a suitable speed with continuous stirring. The reaction mixture temperature and the bath temperature were monitored with a thermometer. After the addition, and 33.75 g of orthoboric acid was added to the flask with stirring. The reaction mixture was stirred until a clear solution was formed. Then, the clear solution was cooled down to room temperature.

### Example 8: Preparation of a Fire Retardant Composition

To a 1 L four neck round bottom flask equipped with a condenser, 22.41 g of water and 220.55 g of 20% aqua ammonia was added. The flask was placed in a cooling bath filled with 2 kg of water and then agitated with a magnetic stirrer. 173.30 g of 85% phosphoric acid was added dropwise through a graduated addition funnel with a pressure equalizing line at a suitable speed with continuous stirring. The reaction mixture temperature and the bath temperature were monitored with a thermometer. After the addition, 33.75 g of orthoboric acid was added to the flask with stirring. The reaction mixture was stirred until a clear solution was formed. Then, the clear solution cooled down to room temperature.

It is believed that other methods according to the present disclosure can produce fire retardant compositions in an efficient manner.

The following numbered clauses are directed to various non-limiting embodiments and aspects according to the present disclosure.
Clause 1. A method for manufacturing an aqueous fire retardant composition, the method comprising: combining a phosphoric acid, an ammonia compound, and a boric acid; and contacting the phosphoric acid with the ammonia compound in an aqueous medium to form a reaction product comprising a phosphate salt, wherein the fire retardant composition comprises the reaction product and the aqueous medium.
Clause 2. The method of clause 1, wherein the combining the phosphoric acid, the ammonia compound, and the boric acid comprises: combining the boric acid and the phosphoric acid to form an intermediate mixture; and combining the intermediate mixture with the ammonia compound.
Clause 3. The method of clause 2, wherein the ammonia compound is added to the intermediate mixture at a rate no greater than 10% of a total volume of the ammonia compound per minute.
Clause 4. The method of clause 1, wherein the combining the phosphoric acid, the ammonia compound, and the boric acid comprises: combining the ammonia compound and the aqueous medium to form an intermediate mixture; and combining the intermediate mixture with the phosphoric acid and the boric acid.
Clause 5. The method of clause 1, wherein the combining the phosphoric acid, the ammonia compound, and the boric acid comprises: combining the ammonia compound and the boric acid to form an intermediate mixture; and combining the intermediate mixture with the phosphoric acid.
Clause 6. The method of clause 1, wherein the combining the phosphoric acid, the ammonia compound, and the boric acid comprises: combining the phosphoric acid and the ammonia compound to form an intermediate mixture; and combining the intermediate mixture with the boric acid.
Clause 7. The method of any of clauses 1-6, wherein the combining the phosphoric acid, the ammonia compound, and the boric acid is performed with agitation.
Clause 8. The method of any of clauses 1-7, wherein the phosphoric acid comprises at least one of orthophosphoric acid, pyrophosphoric acid, triphosphoric acid, and tetraphosphoric acid.
Clause 9. The method of clause 8, wherein the phosphoric acid comprises 10% by weight to 100% by weight active content based on a total weight of the phosphoric acid.
Clause 10. The method of any of clauses 1-9, wherein the ammonia compound comprises aqueous ammonium.
Clause 11. The method of clause 10, wherein the ammonia compound is the aqueous ammonium and the aqueous ammonium comprises 10% by weight to 30% by weight active content of ammonia based on a total weight of the aqueous ammonium.
Clause 12. The method of any of clauses 1-11, wherein the boric acid comprises at least one of orthoboric acid, metaboric acid, and tetraboric acid.
Clause 13. The method of clause 12, wherein the boric acid comprises a purity of at least 95% by weight.
Clause 14. The method of any of clause 1-13, wherein the phosphate salt comprises at least one of monoammonium phosphate and diammonium phosphate.
Clause 15. The method of any of clauses 1-14, wherein the phosphoric acid and the ammonia compound are combined in amounts to achieve a molar ratio of phosphoric acid to ammonia in a range of 0.40 to 0.80.
Clause 16. The method of any of clauses 1-15, wherein the phosphoric acid and the boric acid are combined in amounts to achieve a molar ratio of phosphoric acid to boric acid in a range of 2.0 to 4.0.
Clause 17. The method of any of clauses 1-16, wherein the aqueous fire retardant composition comprises: a phosphate content expressed as P₂O₅ in a range of 15% by weight to 40% by weight based on a total weight of the fire retardant composition; a boric acid content expressed as H₃BO₃ in a range of 5% by weight to 10% by weight based on the total weight of the fire retardant composition; and an ammonium content expressed as NH₃ in a range of 5% by weight to 15% by weight based on the total weight of the fire retardant composition.
Clause 18. The method of any of clauses 1-17, wherein a pH of the fire retardant composition is in a range of 5.0 to 8.0.
Clause 19. The method of any of clauses 1-18, wherein the combining the phosphoric acid, the ammonia compound, and the boric acid is performed at a temperature in a range of 5 degrees Celsius to 85 degrees Celsius.
Clause 20. The method of any of clauses 1-19, wherein the combining the phosphoric acid, the ammonia compound, and the boric acid is performed at a pressure in a range of 10 PSIA to 25 PSIA.
Clause 21. The method of any of clauses 1-20, wherein the combining the phosphoric acid, the ammonia compound, and the boric acid is performed with external cooling.
Clause 22. The method of any of clauses 1-21, wherein the combining the phosphoric acid, the ammonia compound, and the boric acid is performed with condensation.
Clause 23. A fire retardant composition formed by the method of any of clauses 1-22.
Clause 24. A method for treating a wood product, the method comprising contacting the wood product with the fire retardant composition formed by the method of any of clauses 1-22.
Clause 25. A fire retardant wood product formed by contacting a wood product with the fire retardant composition formed by the method of any of clauses 1-22.
Clause 26. A method for manufacturing a fire retardant composition, the method comprising: combining orthophosphoric acid and orthoboric acid to form an intermediate mixture, wherein the intermediate mixture comprises a molar ratio of orthophosphoric acid to orthoboric acid in a range of 2.5 to 3.0; combining aqueous ammonia with the intermediate mixture to achieve a molar ratio of orthophosphoric acid to aqueous ammonia in a range of 0.40 to 0.8, wherein the aqueous ammonia is added to the intermediate mixture at a rate no greater than 10% of a total volume of the aqueous ammonia per minute; and contacting the orthophosphoric acid with the aqueous ammonia to form a reaction product comprising at least one of monoammonium phosphate and diammonium phosphate, wherein the fire retardant composition comprises the reaction product and the orthoboric acid.

As used herein, “at least one of” a list of elements or other items means one of the elements/items or any combination of two or more of the listed elements/items. As an example “at least one of A, B, and C” means any of A only; B only; C only; A and B; A and C; B and C; or A, B, and C.

In this specification, unless otherwise indicated, all numerical parameters are to be understood as being prefaced and modified in all instances by the term “about”, in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described herein should at least be construed in light of the number of reported significant digits and by applying ordinary rounding techniques.

Also, any numerical range recited herein includes all sub-ranges subsumed within the recited range. For example, a range of “1 to 10” includes all sub-ranges between (and including) the recited minimum value of 1 and the recited maximum value of 10, that is, having a minimum value equal to or greater than 1 and a maximum value equal to or less than 10. Any maximum numerical limitation recited in this specification is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited.

The grammatical articles “a,” “an,” and “the,” as used herein, are intended to include “at least one” or “one or more,” unless otherwise indicated, even if “at least one” or “one or more” is expressly used in certain instances. Thus, the articles are used herein to refer to one or more than one (i.e., to “at least one”) of the grammatical objects of the article. Further, the use of a singular noun includes the plural, and the use of a plural noun includes the singular, unless the context of the usage requires otherwise.

Any patent, publication, or other disclosure material identified herein is incorporated by reference into this specification in its entirety unless otherwise indicated, but only to the extent that the incorporated material does not conflict with existing descriptions, definitions, statements, or other disclosure material expressly set forth in this specification. As such, and to the extent necessary, the express disclosure as set forth in this specification supersedes any conflicting material incorporated by reference. Any material, or portion thereof, that is said to be incorporated by reference into this specification, but which conflicts with existing definitions, statements, or other disclosure material set forth herein, is only incorporated to the extent that no conflict arises between that incorporated material and the existing disclosure material. Applicants reserve the right to amend this specification to expressly recite any subject matter, or portion thereof, incorporated by reference herein.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

One skilled in the art will recognize that the herein-described components, devices, operations/actions, and objects, and the discussion accompanying them, are used as examples for the sake of conceptual clarity and that various configuration modifications are contemplated. Consequently, as used herein, the specific examples/embodiments set forth and the accompanying discussion are intended to be representative of their more general classes. In general, use of any specific exemplar is intended to be representative of its class, and the non-inclusion of specific components, devices, operations/actions, and objects should not be taken limiting. While the present disclosure provides descriptions of various specific aspects for the purpose of illustrating various aspects of the present disclosure and/or its potential applications, it is understood that variations and modifications will occur to those skilled in the art. Accordingly, the invention or inventions described herein should be understood to be at least as broad as they are claimed and not as more narrowly defined by particular illustrative aspects provided herein.

What is claimed is:

1. A method for manufacturing an aqueous fire retardant composition, the method comprising:
combining a phosphoric acid, an ammonia compound, and a boric acid; and
contacting the phosphoric acid with the ammonia compound in an aqueous medium to form a reaction product comprising a phosphate salt,
wherein the fire retardant composition comprises the reaction product and the aqueous medium.

2. The method of claim 1, wherein the combining the phosphoric acid, the ammonia compound, and the boric acid comprises:
combining the boric acid and the phosphoric acid to form an intermediate mixture; and
combining the intermediate mixture with the ammonia compound.

3. The method of claim 2, wherein the ammonia compound is added to the intermediate mixture at a rate no greater than 10% of a total volume of the ammonia compound per minute.

4. The method of claim 1, wherein the combining the phosphoric acid, the ammonia compound, and the boric acid comprises:
combining the ammonia compound and the aqueous medium to form an intermediate mixture; and
combining the intermediate mixture with the phosphoric acid and the boric acid.

5. The method of claim 1, wherein the combining the phosphoric acid, the ammonia compound, and the boric acid comprises:
combining the ammonia compound and the boric acid to form an intermediate mixture; and
combining the intermediate mixture with the phosphoric acid.

6. The method of claim 1, wherein the combining the phosphoric acid, the ammonia compound, and the boric acid comprises:
combining the phosphoric acid and the ammonia compound to form an intermediate mixture; and
combining the intermediate mixture with the boric acid.

7. The method of claim 1, wherein the phosphoric acid comprises at least one of orthophosphoric acid, pyrophosphoric acid, triphosphoric acid, and tetraphosphoric acid.

8. The method of claim 1, wherein the ammonia compound comprises aqueous ammonium.

9. The method of claim 1, wherein the phosphate salt comprises at least one of monoammonium phosphate and diammonium phosphate.

10. The method of claim 1, wherein the phosphoric acid and the ammonia compound are combined in amounts to achieve a molar ratio of phosphoric acid to ammonia in a range of 0.40 to 0.80.

11. The method of claim 1, wherein the phosphoric acid and the boric acid are combined in amounts to achieve a molar ratio of phosphoric acid to boric acid in a range of 2.0 to 4.0.

12. The method of claim 1, wherein the aqueous fire retardant composition comprises:
a phosphate content expressed as P₂O₅ in a range of 15% by weight to 40% by weight based on a total weight of the fire retardant composition;
a boric acid content expressed as H₃BO₃ in a range of 5% by weight to 10% by weight based on the total weight of the fire retardant composition; and
an ammonium content expressed as NH₃ in a range of 5% by weight to 15% by weight based on the total weight of the fire retardant composition.

13. The method of claim 1, wherein a pH of the fire retardant composition is in a range of 5.0 to 8.0.

14. The method of claim 1, wherein the combining the phosphoric acid, the ammonia compound, and the boric acid is performed at a temperature in a range of 5 degrees Celsius to 85 degrees Celsius.

15. The method of claim 1, wherein the combining the phosphoric acid, the ammonia compound, and the boric acid is performed at a pressure in a range of 10 PSIA to 25 PSIA.

16. The method of claim 1, wherein the combining the phosphoric acid, the ammonia compound, and the boric acid is performed with external cooling.

17. A fire retardant composition formed by the method of claim 1.

18. A method for treating a wood product, the method comprising contacting the wood product with the fire retardant composition formed by the method of claim 1.

19. A fire retardant wood product formed by contacting a wood product with the fire retardant composition formed by the method of claim 1.

20. A method for manufacturing a fire retardant composition, the method comprising:
combining orthophosphoric acid and orthoboric acid to form an intermediate mixture, wherein the intermediate mixture comprises a molar ratio of orthophosphoric acid to orthoboric acid in a range of 2.5 to 3.0;
combining aqueous ammonia with the intermediate mixture to achieve a molar ratio of orthophosphoric acid to aqueous ammonia in a range of 0.40 to 0.8, wherein the aqueous ammonia is added to the intermediate mixture at a rate no greater than 10% of a total volume of the aqueous ammonia per minute; and
contacting the orthophosphoric acid with the aqueous ammonia to form a reaction product comprising at least one of monoammonium phosphate and diammonium phosphate, wherein the fire retardant composition comprises the reaction product and the orthoboric acid.
